(19) United States
(12) Patent Application Publication
(10) Pub. No.: US 2009/0129611 A1
(43) Pub. Date: May 21, 2009

(54) Microphone Membrane And Microphone Comprising The Same

(75) Inventors: Anton Leidl, Hohenbrunn (DE); Wolfgang Pahl, Munich (DE); Ulrich Wolff, Kaiserslautern (DE)

Correspondence Address: FISH & RICHARDSON PC, P.O. BOX 1022, MINNEAPOLIS, MN, 55440-1022, US

(73) Assignee: EPCOS AG, Munich (DE)

(21) Appl. No.: 11/816,960

(22) PCT Filed: Feb. 8, 2006
(86) PCT No.: PCT/EP06/01120

§ 371 Date: Jan. 9, 2008

(30) Foreign Application Priority Data
Feb. 24, 2005 (DE) 10 2005 008 514.8

(51) Int. Cl. H04R 25/00

(52) U.S. Cl. 381/173

(57) ABSTRACT

The invention relates to a microphone membrane (M1) comprising two piezoelectric layers (PS1, PS2) with c-axes oriented in the same direction. A first electroconductive surface (E11) is formed in the central metal layer and subjected to a first electrical potential. The piezoelectric layers (PS1, PS2) are respectively arranged between the central metal layer (ML2) and an outer metal layer (ML1, ML3). In a preferred embodiment, the membrane (M1) has a largely symmetrical structure in terms of the layer sequence and the layer thickness thereof.

### TECHNICAL FIELD

This patent application describes a microphone membrane that comprises at least one piezoelectric layer.

### BACKGROUND

U.S. Pat. No. 4,816,125 describes a microphone membrane with a piezoelectric layer comprising ZnO and several concentrically arranged electrodes.

The following publication describes a piezoelectric microphone: Mang-Nian Niu and Eun Sok Kim in the Journal of Microelectromechanical Systems, Volume 12, 2003 IEEE, pages 892 through 898, entitled “Piezoelectric Bimorph Microphone Built on Micromachined Parylene Diaphragm.”

### SUMMARY

Described herein is a piezoelectric microphone membrane with a high signal/noise ratio.

A microphone membrane is described that comprises two piezoelectric layers arranged one above the other with a central metal layer located in between them, wherein the c-axes of the two piezoelectric layers are oriented in the same direction.

The membrane may have an essentially symmetrical structure in terms of layer sequence and layer thickness. Even with considerable and abrupt changes in temperature, compensation is thus provided, especially in regard to the bending moments that are produced as a result of the different expansion coefficients of layers that follow one another sequentially. In this way, warping of the membrane can be avoided over a wide temperature range. The central metal layer may be in the plane of symmetry.

The microphone membrane may be used in a microphone. The microphone may be in the form of a microphone chip with a carrier substrate that has a recess, above which the membrane is mounted, and is thereby capable of vibrating. The microphone chip has external contacts on its surface, which are accessible from the outside. The microphone chip can be arranged in a housing with an acoustic back volume.

Silicon, for example, is suitable as the material for the supporting substrate. ZnO, lead zirconate-titanate (PZT), and aluminum nitride are well-suited for the piezoelectric layer.

The piezoelectric layers are each arranged between the central metal layer and a respective external metal layer. A first electrically conductive surface is constructed in the central metal layer. This electrically conductive surface is subjected to a first electrical potential and forms a first internal electrode of the microphone.

In an embodiment, a second electrically conductive surface, which is subjected to a second electrical potential and which forms a second internal electrode of the microphone, can be arranged in the same metal layer as the first internal electrode. In this way, at least one floating structure may be constructed in each of the metal layers that faces outward. This floating structure is located opposite the first and second electrically conductive surfaces. However, the second internal electrode can also be formed by conductive surfaces that are arranged in the external metal layers.

Metal structures that are subjected to an electrical potential are termed internal electrodes or electrodes. The internal electrodes are connected to the external electrodes of the microphone chip via strip conductors and, optionally, vertical electrical connections. For example, the external electrodes can be constructed in one of the externally located layers. The internal electrodes are connected to the external electrodes via electrical leads and vertical electrical connections (i.e., plated through-holes are arranged in the piezoelectric layer in question).

In the case of a bimorphous membrane structure, two capacitors arranged one above the other, with a common electrode, are formed by three metal layers and the piezoelectric layers that are arranged between them. In the event of flexing, the first piezoelectric layer experiences extension and the second piezoelectric layer experiences contraction, or vice versa. In this way, oppositely directed piezo-potentials are produced in the two piezoelectric layers that have the same orientation of their c-axes. These piezo-potentials are, however, additive to one another when the capacitors, which are arranged one above the other, are connected in parallel. Their common electrode, in particular, is constructed in the plane that is arranged between the two piezoelectric layers. The common electrode, which corresponds to the first or second internal electrode, is thus subjected to an electrical potential, and may be connected to an external contact of the microphone chip. In one embodiment, the metal structures that are constructed in the external metal layers and are located opposite the common electrode, are conductively connected to one another and to an additional external contact of the microphone chip via electrical leads and interlayer contacts, for example.

For the same membrane deflection, a bimorphous membrane structure can successfully produce an electrical signal that is twice as large as that in the case of a membrane with only one piezoelectric layer, because the piezo-potentials of the two piezoelectric layers are additive to one another with appropriate circuitry.

In the case of the deflection of a membrane that is firmly clamped at the edge, it is especially the edge region thereof, along with its central region, that is exposed to the greatest mechanical stresses. In this way, the edge region is extended in the event of contraction of the central region, and vice versa. Therefore high, opposing electrical potentials, which are essentially equal in terms of magnitude, are produced in the (ring-shaped) edge region and in the (circular) central region. A region of the piezoelectric layer that lies below the potential limit of 70% of the maximum potential is designated a region of high potential. Furthermore, the centrally arranged region of high potential is termed the first region of high potential, and the region of high potential which is concentric therewith and which is arranged in the edge region, is termed the second region of high potential. The electrodes, which are arranged in different regions of high potential in the same metal layer and which are connected to external electrodes of opposite polarity, may be insulated from one another since potential equalization would otherwise take place.

It is possible to implement an internal electrode via conductive surfaces that are constructed in different metal layers and that are connected to one another electrically, e.g., by interlayer contacts. In one embodiment, a first conductive surface and a second conductive surface are arranged in the central metal layer, where the first conductive surface is located opposite third conductive surfaces arranged in external metal layers, and where the second conductive surface is located opposite fourth conductive surfaces located in external metal layers. The first conductive surface here is connected to the first external electrode, and the fourth conductive surfaces are connected to the second external electrode. The second conductive surface is connected, in an electrically conductive manner, to the third conductive surfaces by interlayer contacts that are arranged in the adjacent piezoelectric layer.

The first conductive surface can be allotted to a first region of high potential, and the second conductive surface can be allotted to a second region of high potential, or vice versa.

The electrodes of opposite polarity may be arranged in the same (central) metal layer. In the second metal layer, at least one floating conductive structure or surface that is capacitively coupled to the electrode in question via the piezoelectric layer located between them is then constructed. Two capacitors connected in series, the galvanic electrodes of which are formed by the floating conductive structure, are formed in this way. In order to reduce the stray capacitance, the floating conductive surface can be structured in such a way that it forms two comparatively broad regions, essentially repeating the shape of the opposite electrode of the capacitor in question, which are connected to one another by, e.g., a narrow strip conductor.

In order to form electrodes, it is advantageous to structure the metal layer in such a way that the intermediate region—a region of low potential—arranged between the central region and the edge region, remains essentially free from metallization.

A region of high potential (which is associated with the first metal layer) can be subdivided into at least two subregions. A first electrode is arranged in the first subregion, and this first electrode is electrically insulated from a second electrode that is associated with the second subregion. Both electrodes are located opposite a floating conductive surface, which is optionally subdivided into two portions connected galvanically to one another, and opposite the electrodes. The two electrodes may have the same surface area. Two capacitors are formed in this way that are connected in series via the floating conductive surface. It is possible to successfully increase the signal potential by a factor of two with such an electrode subdivision, relative to an implementation with non-subdivided electrodes of the same membrane dimensions. It is also possible to connect more than merely two capacitors, formed as above in series. These capacitors may be identical.

In one embodiment, the galvanic connection of the serially connected capacitors takes place via a floating conductive surface. In the case of more than two capacitors that are connected one behind the other, these surfaces are arranged in the first and second metal layer.

In another embodiment, the series connection of the capacitors is possible via vertical electrical connections, e.g., via interlayer contacts that are arranged in the piezoelectric layer.

The two high-potential regions of opposite polarity can also be subdivided, as described above, into subregions with assigned electrodes in order to form several capacitors that are connected one behind the other.

In accordance with another embodiment, a piezoelectric microphone is described with a supporting substrate and a membrane that is mounted above a recess constructed therein. The membrane is clamped only on one side to the supporting substrate, and its end opposite the clamped end can vibrate freely upon the application of an acoustic signal. The membrane may have a bimorphous structure.

In one embodiment, the membrane can be clamped to the supporting substrate in a bridge-like manner. The two opposite ends of the membrane are fastened to the supporting substrate, and the two additional ends of it are not fastened.

The microphone can comprise a vibratable support, e.g., an elastic film (e.g., one comprising a metal or a polymer) or a thin SiO₂ layer on which the membrane is arranged. The vibratable support extends beyond the free end of the membrane and thereby connects the opposite walls of the recess to one another.

Microphone membranes will be explained in detail below by examples and the drawings associated therewith. The drawings show various examples through schematic illustrations that are not true to scale. Identical components, or identically operating components, are labeled with identical reference symbols.

### DESCRIPTION OF THE DRAWINGS

FIG. 1A, a microphone with a membrane that has a bimorphous structure;

FIG. 1B, an equivalent circuit diagram of the microphone in accordance with FIG. 1A;

FIG. 2A, an embodiment of the microphone shown in FIG. 1A, with a structured central metal layer;

FIG. 2B, an equivalent circuit diagram of the microphone in accordance with FIG. 2A;

FIG. 3, an embodiment of the microphone shown in FIG. 1A, with metal layers structured into electrodes;

FIG. 4A, in a cutout, the interconnection of the electrodes in a microphone in accordance with FIG. 2;

FIG. 4B, an equivalent circuit diagram of the microphone in accordance with FIG. 4A;

FIGS. 5, 6A, 7A and 7B, a first metal layer (on the left), a second metal layer (in the center), and a third metal layer (on the right) of a microphone with a bimorphous membrane;

FIG. 6B, in a schematic cross section, a membrane with metal layers that have been structured in accordance with FIG. 6A;

FIGS. 8A, 8B and 8C, a microphone with a unilaterally clamped membrane that comprises a piezoelectric layer; and

FIGS. 9 through 14, a microphone with a unilaterally clamped membrane comprising two piezoelectric layers.

### DETAILED DESCRIPTION

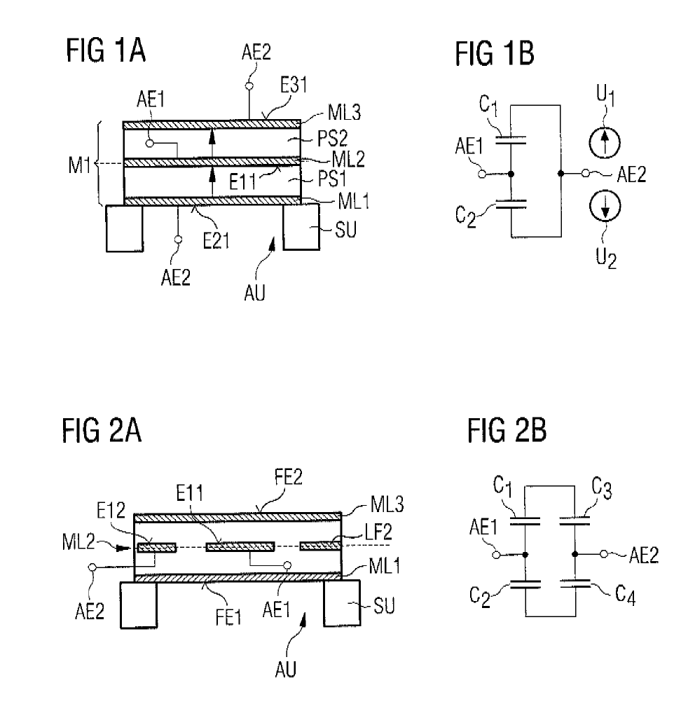

FIG. 1A shows, in a schematic cross section, a microphone chip with a supporting substrate SU and a membrane M1 with a bimorphous structure that is mounted thereon. The membrane M1 can vibrate above a recess AU that is constructed in the supporting substrate.

The membrane M1 has a first piezoelectric layer PS1, which is arranged between an external metal layer ML3 and a central metal layer ML2, as well as a second piezoelectric layer PS2 that is arranged between an external metal layer ML1 and the central metal layer ML2. The direction of the c-axis in the two piezoelectric layers PSI and PS2 is marked by the arrows.

FIG. 1B shows that a first capacitor C₁ is formed between the conductive surfaces E11 and E31 that are located opposite one another and that are constructed in the metal layers ML2 and ML3. A second capacitor C₂ is formed between the conductive surfaces E11 and E21 constructed in the metal layers ML1 and ML2. These capacitors have a common first electrode that is connected to a first external contact AE1. The second electrodes of these capacitors are connected to a second external contact AE2. The capacitors C₁ and C₂ are connected in parallel between the external contacts AE1 and AE2.

The thicknesses of the layers that form the membrane M1 are related to a plane of symmetry that corresponds to the metal layer ML2, and may be symmetric. In this way, the piezoelectric layers have the same thickness and a unidirectional orientation of the c-axes. The two external metal layers ML1 and ML3 are constructed equally thickly as well.

In FIG. 1A, the electrodes, which have opposite polarity and are connected to different external contacts of the microphone, are arranged one above the other. The arrangement of the two electrodes in a plane is shown in FIG. 2A.

A variant of a bimorphous membrane is presented in FIG. 2A. Floating conductive surfaces FE1 and FE2 have been constructed in the two external metal layers ML1 and ML3. These floating conductive surfaces are located opposite the conductive surfaces E11 and E12 that are connected to the external contacts. The first conductive surface E11, which is arranged in the central region of high potential and may be round or square, is connected to the external contact AE1. The ring-shaped second conductive surface E12, which is arranged in the second region of high potential, is connected to the external contact AE2.

The replacement circuit diagram is shown in FIG. 2B. A first capacitor C₁ is formed between the conductive surface E11 and the floating surface E12. A second capacitor C₂ is formed between the conductive surface E11 and the floating surface FE1. In a similar way, the third or fourth capacitor C₃ or C₄ is formed between the conductive surface E12 and the floating surfaces FE1 and FE2, respectively. The series connection of the capacitors C₁ and C₃ is connected in parallel to the series connection of the capacitors C₂and C₄.

FIG. 5 shows a plan view of the metal layers of the membrane in accordance with FIG. 2A.

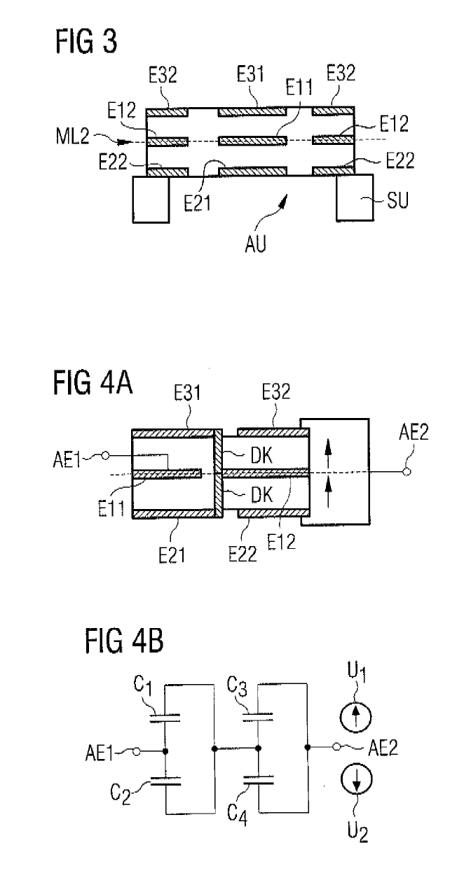

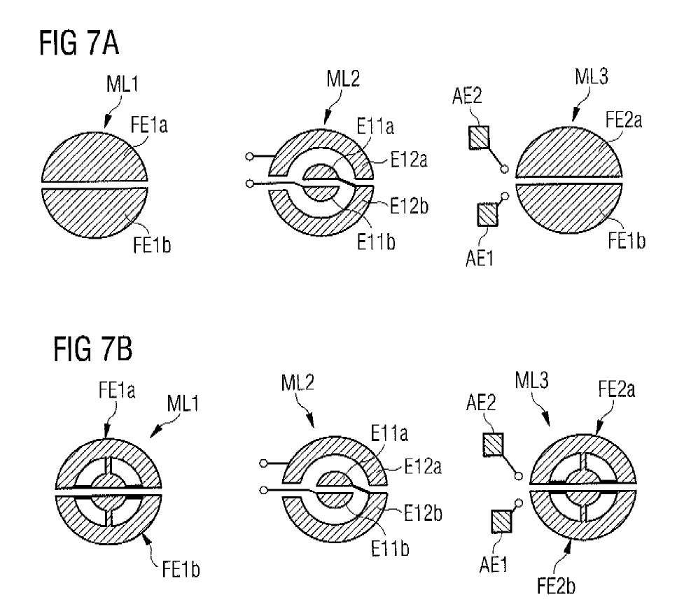

It is specified in FIG. 3 that all three metal layers ML1 through ML3 can be structured to form the conductive surfaces E11, E12, E21, E22, E31 and E32. In an embodiment, the centrally arranged conductive surfaces E11, E21 and E31, which may be round or square, and/or the conductive surfaces E12, E22 and E32, which are arranged in the edge region and may be ring-shaped, can be structured into subsurfaces; see FIG. 7B, for example.

FIGS. 4A and 4B, in the form of a cross section, show an embodiment with an advantageous connection of conductive surfaces that are constructed in three different metal layers in order to form several capacitors, which are connected to one another in series and in parallel, along with the corresponding replacement circuit diagram. FIG. 4A shows the microphone chip only, in the form of a cutout. The conductive surfaces may be constructed in cross-section as in FIG. 3, i.e., essentially concentrically.

A first conductive surface E11 and a second conductive surface E12 are constructed in the central metal layer. A third conductive surface E21 and E31 and a fourth conductive surface E22 and E32 are respectively constructed in the two external metal layers.

The first conductive surface E11 is connected to an external contact AE1 and is arranged between the third conductive surfaces E21 and E31. Two capacitors that are connected one behind the another are formed as a result of this. The first conductive surface E11 here forms a common electrode of these capacitors.

The second conductive surface E12 is arranged between the fourth conductive surfaces E22 and E32. Two capacitors C₃ and C₄ that are connected one behind another are formed as a result of this. The second conductive surface E12 here forms a common electrode of these capacitors. The second conductive surface E12 is electrically connected to the two third conductive surfaces E21 and E31 by interlayer contacts DK. The second conductive surface forms a floating conductive structure with these two third conductive surfaces. The fourth conductive surfaces E22 and E32 are connected to a second external contact AE2.

For example, the first conductive surface E11 is arranged in the centrally located first region of high potential, and the second conductive surface E12 is arranged in the edge region of the membrane, i.e., in the second region of high potential.

The connection of the conductive surfaces is presented in FIGS. 4A and 4B, wherein the parallel connection of the capacitors C₁ and C₂ is connected in series with the parallel connection of additional capacitors C₃ and C₄. It is also possible to arrange more than merely two parallel connections of capacitors one behind the other and to connect them between the external contacts AE1 and AE2. In this way, for example, the fourth conductive surfaces E22 and E32 can be connected, via vertical electrical connections, to an additional conductive surface, arranged in the central metal layer, and forming floating structure, instead of to the external contact AE2. The arrangement of the additional conductive surface between two conductive surfaces, not illustrated here, or their coupling, may correspond to the arrangement of the second conductive surface E12.

Instead of connecting the first conductive surface E11 to the contact AE1, it is also possible to assign this conductive surface to an additional floating structure. The arrangement of the first conductive surface E11 between two conductive surfaces, not illustrated here, or their coupling, may correspond to the arrangement of the second conductive surface E12.

Thus it is possible, with good success, to increase the number of capacitors per membrane via vertical electrical connections, and hence to increase the signal potential as well.

FIGS. 5, 6A, 6B, 7A and 7B show different embodiments for the construction of electrode structures in the three metal layers ML1, ML2 and ML3 in a membrane with a bimorphous structure. FIGS. 5, 6A, 7A and 7B show, in the center, the central metal layer ML2 of the membrane with metal structures constructed therein.

In FIG. 5, a round first conductive surface E11 is arranged in the first region of high potential, and a ring-shaped second conductive surface E12 is arranged in the second region of high potential. The conductive surfaces E11 and E12 form an internal electrode and are respectively connected, via horizontally running strip conductors and vertical electrical connections—interlayer contacts DK1 and DK2—to an external contact AE1 or AE2 that is arranged in the external metal layer ML3, which is the upper one here. In an embodiment, the external contacts AE1 and AE2 of the microphone can be arranged in the same metal layer as the conductive surfaces E11 and E12, and they can be connected to the conductive surfaces E11 and E12 via horizontal electrical connections (electrical leads).

In the two external metal layers ML1 and ML3, respectively, a continuous floating conductive surface FE1 and FE2 is constructed. On the one hand, a continuous floating conductive surface is located opposite the first conductive surface E11 and, on the other hand, a continuous floating conductive surface is located opposite the second conductive surface E12.

In order to give slow pressure equalization, a ventilation opening VE, where the cross-sectional opening size is significantly smaller than the cross-sectional size of the membrane, is provided that passes through the membrane.

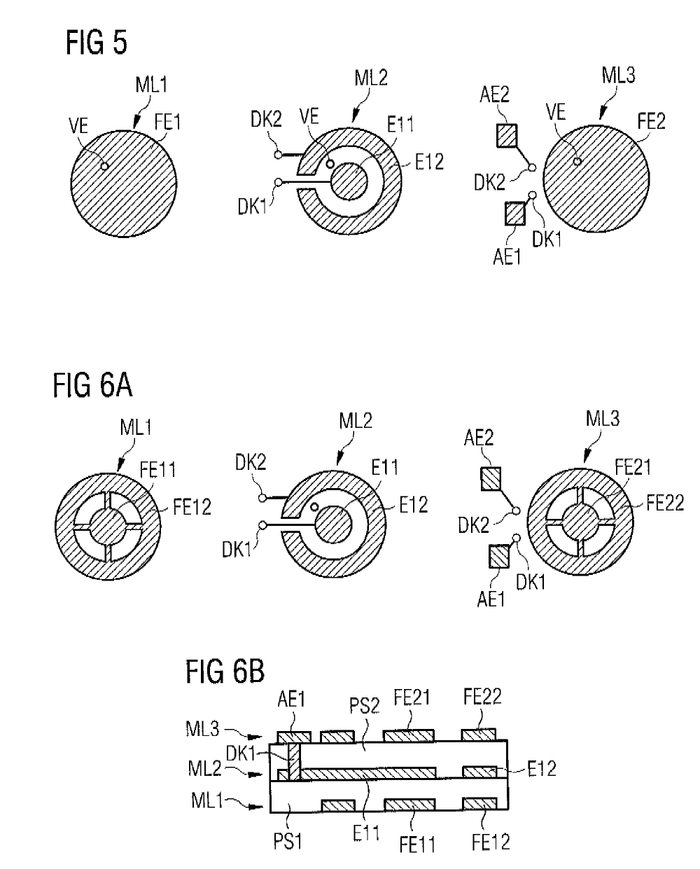

A modification of the membrane in accordance with FIG. 5 is presented in FIGS. 6A and 6B. Here, structured floating surfaces are provided instead of continuous floating conductive surfaces FE1 and FE2. The circular first conductive surface E11 is arranged between two surfaces FE11 and FE21 that have essentially the same shape. The ring-shaped second conductive surface E12 is arranged between two surfaces FE12 and FE22 that have essentially the same shape. The surfaces FE11 and FE12, which are arranged in the central region and in the edge region, respectively, are connected to one another by narrow strip conductors. The surfaces FE21 and FE22, which are arranged in the central region and in the edge region, respectively, are also connected to one another by narrow strip conductors. This embodiment is characterized by low parasitic capacitors.

The membrane with metal layers ML1, ML2 and ML3, which are constructed in accordance with FIG. 6A, is shown in the form of a schematic cross section in FIG. 6B.

An additional embodiment of the construction of metal layers of a bimorphous membrane is shown in FIG. 7A.

A first floating structure, having a first subsurface E12b and a second subsurface E11a connected thereto by a narrow strip conductor, is constructed in the central metal layer ML2.

A second floating structure FE1a and a third floating structure FE1b, which is electrically insulated therefrom, are arranged in the first external metal layer ML1. A second floating structure FE2a and a third floating structure FE2b, which is electrically insulated therefrom, and external contacts AE1 and AE2 are arranged in the second external metal layer ML3.

The second floating structures FE1b and FE2b are located opposite the first conductive surface E11b and a first subsurface E12b of the first floating structure. The third floating structures FE1a and FE2a are located opposite the second conductive surface E12a and a second subsurface Eli a of the first floating structure. In this example, a total of eight capacitors, which are connected to one another, are implemented because the metal structures located opposite one another are coupled capacitively. The equivalent circuit diagram corresponds to the connection one behind the other of the two capacitor circuits in accordance with FIG. 2B.

The first conductive surface El lb and the second subsurface E11a of the first floating structure are arranged in the first region of high potential. The second conductive surface E12a and the first subsurface E12b of the first floating structure are arranged in a second region of high potential.

FIG. 7B shows a modification of the embodiment in accordance with FIG. 7A. The floating structures FE1a, FE1b, FE2a and FE2b, which are constructed in the external metal layers ML1 and ML3, are, in each case, structured in such a way that they have subsurfaces conductively connected to one another by narrow strip conductors. The shape of the subsurfaces corresponds essentially to the shape of the structures E11a, E11b, E12a and E12b that are located opposite them.

The structures, which are arranged in the same metal layers and which are conductively connected to one another, can basically be replaced by a continuous conductive surface (without cutouts). A continuous conductive surface can be replaced by subsurfaces that are conductively connected to one another and the shape of which has been adapted to that of the opposite metal structures.

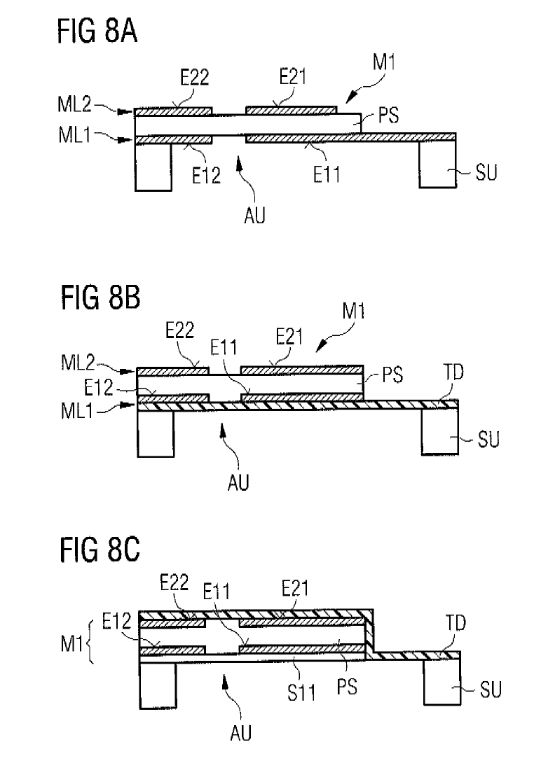

FIGS. 8A-8C show the construction of a microphone chip with a unilaterally clamped membrane M1, whose free end is quasi-elastically connected to the supporting substrate TS. The membrane M1 has a piezoelectric layer PS that is arranged between the structured metal layers ML1 and ML2. First conductive surfaces E11 and E12 are constructed in the metal layer ML1, and second conductive surfaces E21 and E22 are constructed in the metal layer ML2. The membrane M1 is arranged above a recess AU, which is formed in the substrate TS, and it is arranged above the supporting substrate SU on one side only, so that one end of the membrane can vibrate freely. The recess AU may be a continuous opening in the supporting substrate.

In the embodiment shown in FIG. 8A, the free end of the membrane is connected quasi-elastically to the supporting substrate SU via a conductive surface E11 constructed in the lower metal layer ML1.

In FIG. 8B, a support TD, which can vibrate, and the membrane M1 arranged thereon and firmly connected thereto, is mounted above the recess AU. The support TD, which can vibrate, may be highly elastic and allows a large deflection amplitude for the free end of the membrane, and hence a large degree of membrane travel.

In FIG. 8C, the membrane M1 additionally comprises a layer S11, e.g., one comprising silicon dioxide. A support TD, which can vibrate, e.g., an elastic film such as a plastic film, which connects the free end of the membrane to the supporting substrate, is coated on, or laminated on to, the upper side of the membrane. The film here runs down as far as the lowermost membrane layer.

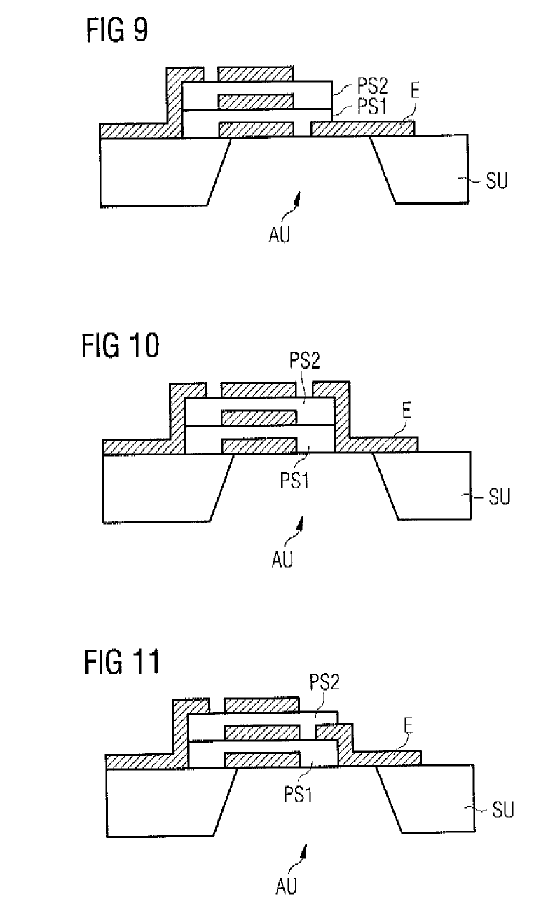

Different embodiments of a unilaterally clamped membrane with a bimorphous structure are shown in FIGS. 9 through 14.

The quasi-elastic coupling of the free end of the membrane can take place, as in FIG. 3, via a metal structure E that is constructed in the lowermost metal layer (FIG. 9). The metal structure E can also be constructed in the upper or central metal layer and it can run down as far as the plane that corresponds to the lowermost membrane layer (FIGS. 10 and 11).

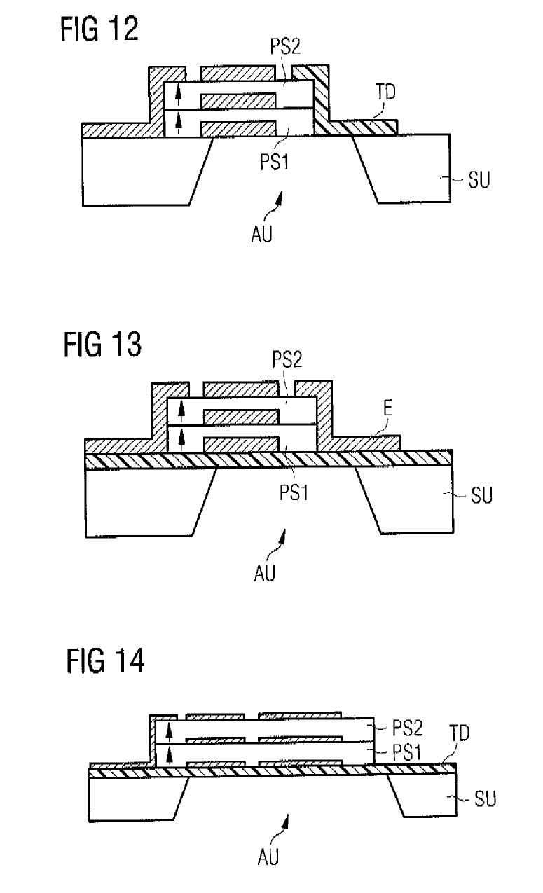

A unilaterally clamped bimorphous membrane, the free end of which is connected to the supporting substrate SU by a vibratable support TD, is shown (on the left) in the embodiment of FIG. 12. Here, the support TD, which can vibrate, covers only a portion of the upper side of the membrane, but it can completely cover the upper side of the membrane as in FIG. 4.

FIG. 13 shows an embodiment of the coupling of the free end of the membrane arranged on a vibratable support TD by the vibratable support TD, and an additional metal structure E, missing in FIG. 14, that is arranged above it.

An additional metal structure which connects the upper side of the membrane, at its clamped end, to the upper side of the supporting substrate, is arranged in FIGS. 9 through 13.

The microphone membranes can also be used in additional piezoelectric acoustic sensors, e.g., distance sensors that operate via ultrasound. A microphone chip with a microphone membrane can be inserted into any desired signal processing module.

Different embodiments can be combined with one another.

1. A microphone membrane comprising:
piezoelectric layers that are stacked; and
a first metal layer among the piezoelectric layers;
wherein axes of the piezoelectric layers are oriented in a the same direction.

2. The microphone membrane of claim 1, further comprising:
a second metal layer and a third metal layer;
wherein the piezoelectric layers between the second and third metal layers.

3. The microphone membrane of claim 1, wherein the microphone membrane has a substantially symmetrical structure in terms of layer sequence and layer thickness; and
wherein the first metal layer is in a plane of symmetry associated with the substantially symmetrical structure.

4. The microphone membrane of claim 2, wherein the first metal layer comprises a first conductive surface; and
wherein the first conductive surface is for receiving a first electric potential.

5. The microphone membrane of claim 4, wherein the second metal layer comprises a second conductive surface and the third metal layer comprises third conductive surface; and
wherein the second conductive surface and the third conductive surface are for receiving a second electrical potential.

6. The microphone membrane of claim 1, wherein the first metal layer comprises a first internal conductive surface for receiving a first electrical potential, and wherein the microphone membrane further comprises:
a second internal conductive surface among the piezoelectric layers
wherein the second internal conductive surface is for receiving a second electrical potential.

7. The microphone membrane of claim 6, wherein a further comprising:
first and second external conductive surfaces, the piezoelectric layers being between the first and second external conductive surfaces;
wherein the first and second external conductive surfaces face the first and second internal conductive surfaces.

8. The microphone membrane of claim 7, wherein the first and second external conductive surfaces are floating.

9. The microphone membrane of claim 7, wherein the first internal conductive surface is in a central region of high potential, and the second internal conductive surface is in a region of high potential that is in an edge region; or vice versa
wherein the second internal conductive surface is in the central region of high potential, and the first internal conductive surface is in a region of high potential that is in the edge region.

10. The microphone membrane of claim 7, wherein the first internal conductive surface is electrically connected to a first electrode at the first external conductive surface via a first electrical connection; and
wherein the second internal conductive surface is electrically connected to a second electrode at the second external conductive surface via a second electrical connection.

11. The microphone membrane of claim 1, wherein the first metal layer comprises a first internal conductive surface, and wherein the microphone member further comprises:
a second internal conductive surface,
a first external conductive surface;
a second external conductive surface;
a third external conductive surface; and
a fourth external conductive surface;
wherein the first and second external conductive surfaces are adjacent to a first piezoelectric layer, and the third and fourth external conductive surfaces are adjacent to a second piezoelectric layer;
wherein the first internal conductive surface is between the first external conductive surface and the third external conductive surface; and
wherein the second internal conductive surface is between the second external conductive surface and the fourth external conductive surface.

12. The microphone membrane of claim 11, wherein the first internal conductive surface is for receiving a first electrical potential;
wherein the second and fourth external conductive surfaces are for receiving a second electrical potential; and
wherein the second internal conductive surface is electrically connected to the first and third external conductive surfaces via interlayer contacts in the piezoelectric layers.

13. The microphone membrane of claim 1, wherein the first metal layer comprises a first floating structure;
wherein the microphone membrane further comprises first and second external metal layers, the piezoelectric layers being between the first and second metal layers;
wherein at least one of the first and second external metal layers comprises a second floating structure and a third floating structure, the first floating structure being electrically insulated from the second floating structure;
wherein the second floating structure is opposite a first conductive surface of the microphone membrane and a first portion of the first floating structure; and
wherein the third floating structure is opposite a second conductive surface of the microphone membrane and a second portion of the first floating structure.

14. The microphone membrane of claim 13, wherein the first conductive surface and the second portion of the first floating structure are in a first region of high potential; and
wherein the second conductive surface and the first portion of the first floating structure are in a second region of high potential.

15. A microphone comprising:
the microphone membrane of claim 1; and
a supporting substrate;
wherein the microphone membrane is mounted above a recess in the supporting substrate.

16. The microphone of claim 15, wherein the microphone membrane is clamped to the supporting substrate on one side only, and wherein an opposite side of the membrane to the one side that is clamped can vibrate upon application of an acoustic signal.

17. The microphone of claim 15, wherein opposite sides of the membrane are fastened to the supporting substrate, and wherein additional opposite ends of the membrane are not fastened to the supporting substrate and can vibrate.

18. A microphone comprising
a supporting substrate having a recess; and
a membrane mounted above the recess, wherein the membrane is clamped to the supporting substrate on one side of the membrane only, and wherein another side of the membrane can vibrate upon application of an acoustic signal.

19. A microphone comprising:
a supporting substrate having a recess;
a membrane mounted above the recess, wherein different ends of the membrane are fastened to the supporting substrate, and wherein other different ends of the membrane are not fastened to the supporting substrate and can vibrate upon application of an acoustic signal.

20. The microphone of claim 18, wherein the membrane comprises at least one piezoelectric layer.

21. The microphone of claim 18, further comprising:
an elastic support that can vibrate and to which the membrane is connected;
wherein the elastic support extends beyond a free end of the membrane connects the opposite walls of the recess to one another.

22. The microphone of claim 21, wherein the membrane is on the elastic support.

23. The microphone of claim 21, wherein the elastic support runs along an upper side and a lateral surface of the free end of the membrane.

24. The microphone of claim 21, further comprising:
a metal structure connected to the membrane that projects beyond the free end of the membrane and connects the free end and a wall of the recess, wherein the wall is located opposite the free end.

25. The microphone of claim 24, wherein the metal structure is constructed in a lowermost metal layer of the membrane.

26. The microphone of claim 24, wherein the metal structure runs partially in a central or uppermost metal layer of the membrane and along a lateral surface of the free end of the membrane.
